(19) United States
(12) Patent Application Publication
(10) Pub. No.: US 2002/0111486 A1
(43) Pub. Date: Aug. 15, 2002

(54) Transition metal-cyclopentadienyl-tropane conjugates

(76) Inventors: Gilles Denis Tamagnan, Woodbridge, CT (US); Ronald Martin Baldwin, Guilford, CT (US); Robert B. Innis, Rockville, MD (US)

Correspondence Address: MORGAN LEWIS & BOCKIUS LLP, 1111 PENNSYLVANIA AVENUE NW, WASHINGTON, DC, 20004, US

(21) Appl. No.: 09/727,076

(22) Filed: Dec. 1, 2000

Related U.S. Application Data
(60) Provisional application No. 60/168,671, filed on Dec. 3, 1999.

(51) Int. Cl. C07F 13/00

(52) U.S. Cl. 546/10; 534/14

(57) ABSTRACT

Transition metal-cyclopentadienyl-tropane conjugate compounds are described. Methods for preparing transition metal-cyclopentadienyl-tropane conjugate compounds are also described. Transition metal-cyclopentadienyl-tropane conjugate compounds of the invention exhibit an affinity for monoamine transporters and are useful as diagnostic and/or therapeutic agents.

### RELATED APPLICATIONS

This application claims benefit of priority under 35 U.S.C. § 119(e) to U.S. Provisional Application No. 60/168,671 filed on Dec. 3, 1999, which is incorporated in its entirety by reference.

This invention was partially made with government support under the Department of Veterans Affairs (Merit Review Award to R. B. Innis, entitled “SPECT Imaging of Dopamine Transporters”).

### FIELD OF THE INVENTION

The invention relates to novel transition metal-cyclopentadienyl-tropane conjugate compounds. The invention also relates to methods of preparing transition metal-cyclopentadienyl-tropane conjugate compounds. The transition metal-cyclopentadienyl-tropane conjugate compounds exhibit affinity for monoamine transporters and are useful in various diagnostic methods such as, for example, clinical diagnosis of Parkinson's disease.

### BACKGROUND OF THE INVENTION

Radioiodinated compounds have been used for imaging the dopamine transporter (DAT). β-Carbomethoxy-3β-(4-iodophenyl) tropane (β-CIT or RTI-55) have been labeled with ¹²⁵I for an in vitro probe with homogenate binding studies and ¹²³I for single photon emission computed tomography (SPECT) imaging. Neumeyer, et al., J. Med. Chem., 34:3144-3146 (1991); Carroll, et al., J. Med. Chem., 34:2719-2725 (1991). N-omega-fluoroalkyl ¹²³I-aryl tropane derivatives as well as N-¹²³I-allyl iodo- or chloro-substituted aryl tropane derivatives have also been used for DAT imaging. U.S. Pat. No. 5,310,912; Goodman, et al., J. Nucl. Med., 33:890 (1992); Goodman, et al., J. Nucl. Med., 37:1535-1542 (1994); Malison, et al., J. Nucl. Med., 36:2290-2297 (1995); Fischman, et al., Neuroscience-Net 1: Article #10010 (1996); Fischman, et al., J. Nucl. Med., 38:144-150 (1987); Fischman, et al., J. Nucl. Med., 35:87P (1995); Elmaleh, et al., J. Nucl. Med., 37:1197-1202 (1996); U.S. Pat. No. 5,864,038; U.S. Pat. No. 5,853,696. However, iodinated tracers are expensive to use. In addition, ¹²³I is not readily available. In fact, only a limited number of cyclotrons in North America commercially produce ¹²³I.

N₂S₂ phenyl tropane conjugates have also been explored for use in SPECT imaging of the dopamine transporter. Such compounds include a ^{99m}Tc complex of an N₂S₂ chelate conjugated at the Opposition of 3β-(4-chlorophenyl)tropane (TRODAT-1), an N-substituted ^{99m}Tc complex of an N₂S₂ chelate analog of β-carbomethoxy-3β-(4-chlorophenyl) tropane (CFT)-(Technepine), and a ^{99m}Tc complex of an N₂S₂ chelate conjugated at the 2β-position of 3β-(4-iodophenyl)tropane (β-CIT-BAT). Kung, et al., Eur. J. Nucl. Med., 23:1527-1530 (1996); Madras, et al., Synapse, 22:239-246 (1996); Tamagnan, et al., Tetrahedron Lett., 37:4353-4356 (1996); Mozley, et al., J. Nucl. Med., 39: 2069-2076 (1998); Kushner, et al., J. Nucl. Med., 40:150-158 (1999). However, the N₂S₂ chelate system suffers from nonspecific binding due to the high lipophilicity and high molecular weight of the N₂S₂ phenyl tropane conjugates. Another drawback to the N₂S₂ chelate system is the syn/anti isomerism of the Tc═O complex, which often leads to a mixture of products, reducing the effectiveness of the radiotracer.

Conjugates of cyclopentadienyl metal-tricarbonyl [CpM(CO)₃] and derivatives of 2β-carbomethoxy-3β-p-iodophenyltropane have been studied for dopamine transporter activity. J. L. Neumeyer et al., U.S. Pat. No. 5,700,446: Dec. 23 (1997); G. Tamagnan et al., Quart. J. Nucl. Med. 42: 39 (1998); S. S. Zoghbi et al., J. Nucl. Med. 38: 100P (1997). In such conjugates, the cyclopentadienyl metal-tricarbonyl [CpM(CO)₃] moiety is attached at the 2-position of the tropane moiety by means of a reverse ester linkage. A conjugate of cyclopentadienyl metal-tricarbonyl [Cp^{99m}Tc(CO)₃] and tropanol in which the [Cp^{99m}Tc(CO)₃] is attached via an ether linkage at the 3β-position has also been described. U.S. Pat. No. 5,538,712. However, such compounds are often difficult to synthesize and must be prepared under severe reaction conditions that may lead to undesired side reactions.

Thus, despite these earlier efforts, there still exists a need in the art for stable, easily accessible compounds that exhibit monoamine transporter activity. The invention as described below answers such a need.

### SUMMARY OF THE INVENTION

The invention provides transition metal-cyclopentadienyl-tropane conjugate compounds of formulae (I), (III), (IV), (VI) and (VII):

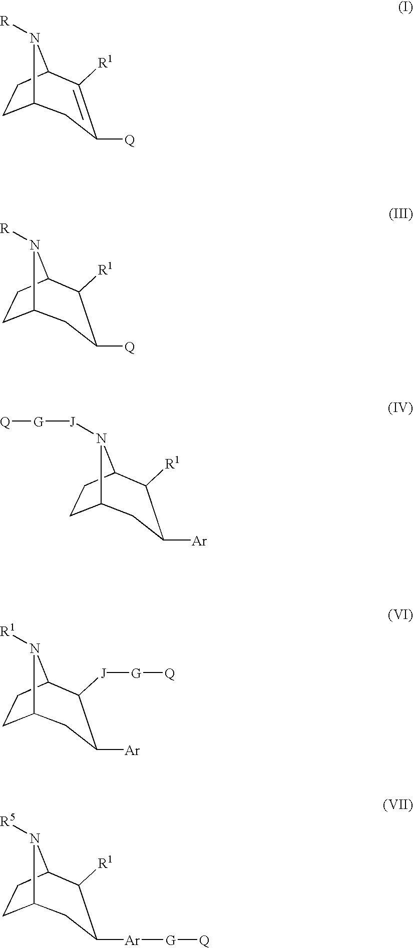

The invention also provides a method of preparing transition metal-cyclopentadienyl-tropane conjugate compounds of formulae (I), (III), (IV), (VI) and (VII) as illustrated above.

The invention further provides pharmaceutical compositions for the treatment of disorders related to monoamine transporter activity comprising a therapeutically effective amount of at least one transition metal-cyclopentadienyl-tropane conjugate compound of formulae (I), (III), (IV), (VI) or (VII) and a pharmaceutically acceptable carrier.

The invention still further provides a radiodiagnostic method comprising the steps of administering to a mammal a pharmaceutically acceptable amount of at least one radioisotopic transition metal-cyclopentadienyl-tropane conjugate compound of formulae (I), (III), (IV), (VI) or (VII) and then monitoring uptake of the radioisotopic transition metal-cyclopentadienyl-tropane conjugate compound(s).

### DETAILED DESCRIPTION OF THE INVENTION

Transition metal-cyclopentadienyl-tropane conjugate compounds of the invention are neutral and lipophilic compounds. The transition metal-cyclopentadienyl-tropane conjugate compounds of the invention have monoamine transporter activity, i.e., they exhibit an affinity for monoamine transporters. In a preferred embodiment of the invention, the transition metal-cyclopentadienyl-tropane conjugate compounds of the invention exhibit an affinity for monoamine transporters of less than about 20 nM, preferably, less than about 15 nM, and more preferably, less than about 10 nM. Preferably, the monoamine transporter is a dopamine transporter, a serotonin transporter or a norepinephrine transporter, more preferably, a dopamine or serotonin transporter, and most preferably, a dopamine transporter. According to the invention, a transition metal-cyclopentadienyl-tropane conjugate compound contains at least three components: a transition metal, a cyclopentadienyl group and a tropane moiety.

Transition Metal

The transition metal (M) may be any transition metal capable of forming a compound with a cyclopentadienyl (Cp) moiety, as described below. According to the invention, the transition metal may also be a radioactive isotope or radioisotope of a transition metal, as described above. Preferably, a transition metal radioisotope provides negligible particle emission, primary gamma emission in an energy range of about 100-511 keV and a half life of about 30 minutes to about 2.5 days. In a preferred embodiment of the invention, the transition metal is technetium (Tc), rhenium (Re), manganese (Mn) or a radioactive isotope or radioisotope thereof (e.g. ⁹⁹mTc, ⁹⁴mTC, ¹⁸⁶Re, ¹⁸⁸Re, ⁵⁶Mn). As would be understood by one of skill in the art, the transition metal (M) may also be associated with various ligands such as, for example, carbon monoxide (CO or carbonyl), CH₃CN, NO, and alkyl or aryl phosphines (e.g. triphenylphosphine) to form a metal-ligand complex with the cyclopentadienyl moiety (e.g. CpM(CO)₃).

Cyclopentadienyl Group

A cyclopentadienyl group, as recognized by one of skill in the art, may be any substituted or unsubstituted aromatic C₅H₅ anion of the following general formula:

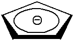

Possible substituents include, but are not limited to, hydrogen, alkyl, alkenyl, alkynyl, aryl , acyl, and carboxylate groups. As discussed above, a cyclopentadienyl group is capable of reacting with a transition metal to form a transition metal-cyclopentadienyl compound of the general formula:

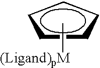

where p is an integer from 0-3, preferably, 3 and where M and the ligand are each as described above. The cyclopentadienyl group of a transition metal-cyclopentadienyl compound may be covalently or noncovalently bound to the transition metal or the metal-ligand complex, each as described above. Such covalent and noncovalent binding may be any such binding means known in the art.

Tropane Moiety

The tropane moiety of a transition metal-cyclopentadienyl-tropane conjugate compound of the invention may be any tropane having the following basic structure:

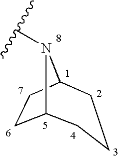

According to the invention, the bicyclic ring system of the tropane moiety may be saturated or unsaturated. Also according to the invention, the tropane moiety may be substituted or unsubstituted. Further according to the invention, the tropane moiety may be substituted at more than one position. In a preferred embodiment of the invention, the tropane moiety of an integrated transition metal-cyclopentadienyl-tropane conjugate compound, as described below, contains an unsaturated bicyclic ring system, more preferably, an unsaturated bicyclic ring system of the general formula:

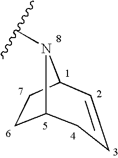

In another preferred embodiment of the invention, the tropane moiety of a pendant transition metal-cyclopentadienyl-tropane conjugate compound, as described below, contains a saturated bicyclic ring system. The tropane moiety, as described above, may be substituted or unsubstituted. Examples of suitable substituents include, but are not limited to, linear or branched, saturated or unsaturated esters, ethers, and alcohols, and substituted or unsubstituted aryl groups. In a preferred embodiment of the invention, the tropane moiety is substituted at the 2-position with a linear or branched, saturated or unsaturated ester, ether, or alcohol. In another preferred embodiment of the invention, the tropane moiety of a pendant transition metal-cyclopentadienyl-tropane conjugate compound, as described below, is substituted at the 3-position with a substituted or unsubstituted aryl group, more preferably, a substituted phenyl group. Possible aryl substituents include, but are not limited to, hydroxy, saturated and unsaturated alkoxide, halo (e.g. I, Cl, Br, F), amino, carboxyl, carboxylate, and nitro groups or a combination thereof

Integrated and Pendant Transition Metal-Cyclopentadienyl-Tropane Conjugates

According to the invention, a transition metal-cyclopentadienyl compound may be either directly or indirectly attached to the tropane moiety, each as described above. If the transition metal-cyclopentadienyl compound is directly attached to the tropane moiety by means of a covalent bond, an “integrated” transition metal-cyclopentadienyl-tropane conjugate compound results. In a preferred embodiment of the invention, the transition metal-cyclopentadienyl compound is directly attached to the tropane moiety at the 3-position. An integrated transition metal-cyclopentadienyl-tropane conjugate compound of the invention may be prepared by any means known in the art. Preferably, an integrated transition metal-cyclopentadienyl-tropane conjugate compound may be prepared by reaction of a transition metal-cyclopentadienyl compound with a tropane moiety substituted at the desired position of attachment with a leaving group (e.g. B(OH)₂) under conditions sufficient to form the desired transition metal-cyclopentadienyl-tropane conjugate compound. For example, an integrated transition metal-cyclopentadienyl-tropane conjugate compound may be prepared under Suzuki coupling conditions, Stille coupling conditions, or “Minutolo-Katzenellenbogen” reaction conditions. Preferably, an integrated transition metal-cyclopentadienyl-tropane conjugate compound is prepared under “Minutolo-Katzenellenbogen” reaction conditions. F. Minutolo et al., Organometallics, 18:2519-2530 (1999).

If the transition metal-cyclopentadienyl moiety is indirectly attached to the tropane moiety by means of a linker group, a “pendant” transition metal-cyclopentadienyl-tropane conjugate compound results. The linker group of a pendant transition metal-cyclopentadienyl-tropane conjugate compound may be any group capable of covalently linking together a transition metal-cyclopentadienyl compound and a tropane moiety, each as described above. As would be understood by one of skill in the art, the linker group may vary in length. Examples of suitable linker groups include, but are not limited to, alkenyl, saturated or unsaturated ketone, ester, acid, amide, glycol, sulfoxide, sulfonyl, and benzoyl groups. According to the invention, linkage of the transition metal-cyclopentadienyl compound to the tropane moiety, each as described above, results in minimal perturbation of receptor-binding properties of the final compound. In a preferred embodiment of the invention, linkage occurs through the nitrogen atom, i.e. at the 8-position, of the tropane moiety, as described above. In another preferred embodiment of the invention, linkage occurs at the 3-position of the tropane moiety. A “pendant” transition metal-cyclopentadienyl-tropane conjugate compound may be prepared by any means known in the art. See, for example, G. Tamagnan et al., Quart. J. Nucl. Med. 42: 39 (1998). Preferably, a “pendant” transition metal-cyclopentadienyl-tropane conjugate compound is prepared by means of an electrophilic addition reaction or a nucleophilic addition reaction, each as described below. Accordingly, a transition metal-cyclopentadienyl complex may be functionalized with a linker group and then reacted with a tropane moiety under conditions sufficient to form a transition metal-cyclopentadienyl-tropane conjugate compound, each as described above. Alternatively, a tropane moiety may be functionalized with a linker group and then reacted with a transition metal-cyclopentadienyl complex under conditions sufficient to form a transition metal-cyclopentadienyl-tropane conjugate compound, each as described above. As would be recognized by one of skill in the art, “under conditions sufficient” would include electrophilic or nucleophilic addition reaction conditions or other suitable coupling reaction conditions known in the art. In a preferred embodiment of the invention, both integrated and pendant transition metal-cyclopentadienyl-tropane conjugate compounds, as described above, may be prepared by treating the corresponding ferrocene tropane precursor, i.e. a transition metal-cyclopentadienyl-tropane compound in which the transition metal-cyclopentadienyl complex is replaced with a symmetrical or unsymmetrical ferrocene [(Cp)₂Fe or CpFeCp′] moiety, under double ligand transfer reaction conditions. Spradau, et al., Organometallics, 17:2009 (1998).

In a preferred embodiment of the invention, an integrated transition metal-cyclopentadienyl-tropane conjugate compound is of formula (I):

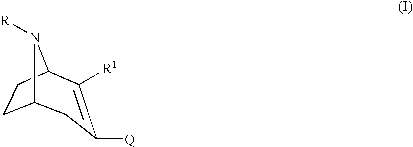

In formula (I):

R¹ is CO₂R² or CH₂OR²; preferably, CO₂ R²; most preferably, CO₂CH₃.

R and R² are, independently, H, linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S; preferably, a linear or branched C₁-C₈ alkyl, C₂-C₈ alkenyl, or C₂-C₈ alkynyl group; more preferably, a methyl group;

Q is substituted or unsubstituted CpM(CO)₃;

M is Re, Tc, Mn or a radioisotope thereof, preferably, Re, Tc, or a radioisotope thereof; and

Cp is a cyclopentadienyl group.

According to the invention, an integrated transition metal-cyclopentadienyl-tropane conjugate compound of formula (I), as described above, may be prepared by reacting a compound of formula (II):

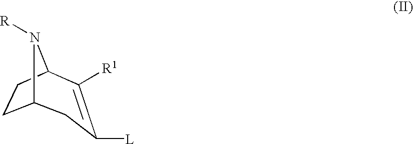

wherein R and R¹ are each as described above for formula (I) and L is B(OH)₂, with a transition metal-cyclopentadienyl compound under conditions sufficient, as described above, to form a transition metal-cyclopentadienyl-tropane conjugate compound of formula (I).

In another preferred embodiment of the invention, an integrated transition metal-cyclopentadienyl-tropane conjugate compound is of formula (III):

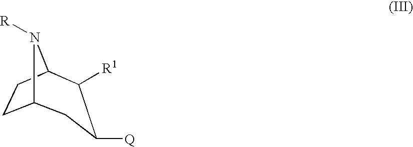

In formula (III):

R¹ is CO₂R² or CH₂ OR²; preferably, CO₂ R²; most preferably, CO₂CH₃;

R and R² are, independently, H, linear or branched C₁-C₁₂ alkyl C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S; preferably, linear or branched C₁-C₈ alkyl, C₂-C₈ alkenyl, C₂-C₈ alkynyl group; more preferably, a methyl group;

Q is substituted or unsubstituted CPM(CO)₃;

M is Re, Tc, Mn or a radioisotope thereof; preferably, Re, Tc, or a radioisotope thereof; and

Cp is a cyclopentadienyl group.

According to the invention, an integrated transition metal-cyclopentadienyl-tropane conjugate compound of formula (III), as described above, may be prepared by reducing under conditions sufficient an integrated transition metal-cyclopentadienyl-tropane conjugate compound of formula (I). As would be understood by one of skill in the art, “under conditions sufficient” include any suitable reduction methods known in the art capable of selectively reducing only the C2-C3 double bond of the tropane moiety.

In a preferred embodiment of the invention, a pendant transition metal-cyclopentadienyl-tropane conjugate compound is of formula (IV):

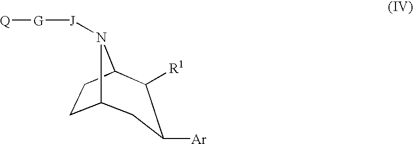

In formula (IV):

Q is substituted or unsubstituted CpM(CO)₃;

M is Re, Tc, Mn or a radioisotope thereof; preferably, Re, Tc, or a radioisotope thereof;

Cp is a cyclopentadienyl group;

G is a direct link, —C(O)—, —R²NC(O)—, —CH═CH—, —S(O)—, —SO₂—, —OC(O)—, or —CH₂—O—(CH₂)ᵣ—O—(CH₂)ₛ—; preferably, —C(O)—, —OC(O)—, or —CH═CH—;

r is an integer from 1-4; preferably, r is 1;

s is an integer from 0-4, where r+s<8; preferably, s is 3, where r+s=4;

J is —(CH₂)ₙ—;

n is an integer from 1-8; preferably, n is an integer from 1-4; most preferably, n is 3;

R¹ is CO₂R² or CH₂OR³; preferably, CH₂OH or CO₂CH₃

R² and R⁴ are, independently, H, a linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S; preferably, a linear or branched C₁-C₈ alkyl, C₂-C₈ alkenyl, C₂-C₈ alkynyl group; more preferably, a methyl group;

R³ is H, —CH₂—O—(CH₂)ₜ—O—(CH₂)ᵥ—, a linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S; preferably, a linear or branched C₁-C₈ alkyl, C₂-C₈ alkenyl, C₂-C₈ alkynyl group; more preferably, a methyl group;

t is an integer from 1-4; preferably, t is 1;

v is an integer from 0-4, where t+v<8; preferably, v is 3, where t+v=4;

Ar is a substituted or unsubstituted phenyl group; preferably, a p-chlorophenyl group, with the proviso that when R¹ is CO₂CH₃ or CH₂OH, G is not C(O).

According to the invention, a pendant transition metal-cyclopentadienyl-tropane conjugate compound of formula (IV), as described above, may be prepared by reacting a tropane moiety of formula (V):

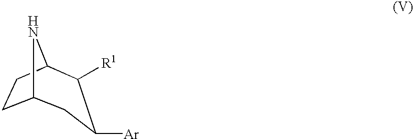

wherein R¹ and Ar are each as described above in formula (IV), with a transition metal-cyclopentadienyl compound under conditions sufficient to form the pendant transition metal-cyclopentadienyl-tropane conjugate compound of formula (IV). According to the invention, “under conditions sufficient” include any suitable electrophilic or nucleophilic addition reaction conditions or coupling reaction conditions, as described above.

In a preferred embodiment of the invention, a pendant transition metal-cyclopentadienyl-tropane conjugate compound is of formula (VI):

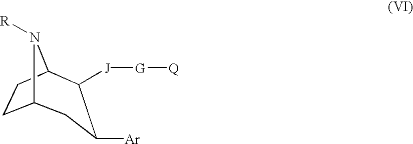

In formula (VI):

Q is substituted or unsubstituted CpM(CO)₃;

M is Re, Tc, Mn or a radioisotope thereof, preferably, Re, Tc, or a radioisotope thereof;

Cp is a cyclopentadienyl group;

G is a direct link, —C(O)—, —R²NC(O)—, —CH═CH—, —S(O)—, —SO₂—, —OC(O)—, or —CH₂—O—(CH₂)ᵣ—O—(CH₂)ₛ—; preferably, —C(O)—, —OC(O)—, or —CH═CH—;

r is an integer from 1-4; preferably, r is 1;

s is an integer from 0-4, where r+s<8; preferably, s is 3, where r+s 4;

J is —(CH₂)ₙ—;

n is an integer from 1-8; preferably, n is an integer from 1-4; most preferably, n is 3;

R¹ is CO₂R² or CH₂OR³; preferably, CH₂OH or CO₂CH₃;

R² and R⁴ are, independently, H, a linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S; preferably, a linear or branched C₁-C₈ alkyl, C₂-C₈ alkenyl, C₂-C₈ alkynyl group; more preferably, a methyl group;

R³ is H, —CH₂—O—(CH₂)ₜ—O—(CH₂)ᵥ—, a linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S; preferably, a linear or branched C₁-C₈ alkyl, C₂-C₈ alkenyl, C₂-C₈ alkynyl group; more preferably, a methyl group;

t is an integer from 1-4; preferably, t is 1;

v is an integer from 0-4, where t+v<8; preferably, v is 3, where t+v=4;

Ar is a substituted or unsubstituted phenyl group; preferably, a p-chlorophenyl group.

According to the invention, a pendant transition metal-cyclopentadienyl-tropane conjugate compound of formula (VI), as described above, may be prepared by reacting a tropane derivative compound of formula (X):

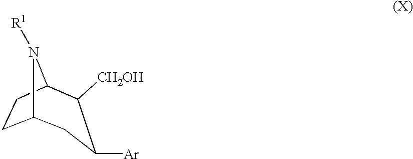

where R¹ and Ar are each as described above in formula (VI), with a transition metal with a transition metal-cyclopentadienyl compound under conditions sufficient to form the pendant transition metal-cyclopentadienyl-tropane conjugate compound of formula (VI). According to the invention, “under conditions sufficient” include any suitable coupling reaction conditions (e.g. Pd coupling).

The invention also provides a pendant transition metal-cyclopentadienyl-tropane conjugate compound of formula (VII):

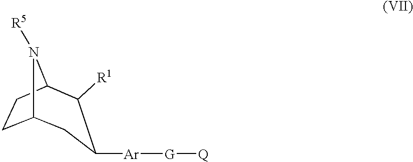

In formula (VII):

Q is substituted or unsubstituted CpM(CO)₃;

M is Re, Tc, Mn or a radioisotope thereof; preferably, Re, Tc, or a radioisotope thereof;

Cp is a cyclopentadienyl group;

G is —C(O)—, —R²NC(O)—, —CH═CH—, —S(O)—, —SO₂—, —OC(O)—, or —Ph—C(O)—; preferably, —C(O)—, —OC(O)—, —CH═CH—, or —Ph—C(O)—; more preferably, —Ph—C(O)—;

R¹ is CO₂R² or CH₂OR³; preferably, CH₂OH or CO₂CH₃;

R², R³, R⁴, and R⁵ are, independently, H, linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S; preferably, linear or branched C₁-C₈ alkyl, C₂-C₈ alkenyl, C₂-C₈ alkynyl group; more preferably, a methyl group; and

Ar is a substituted or unsubstituted phenyl group.

According to the invention, a pendant transition metal-cyclopentadienyl-tropane conjugate compound of formula (VII), as described above, may be prepared by reacting under conditions sufficient a substituted nucleophilic tropane moiety of formula (VIII) with a metal-cyclopentadienyl compound of formula (IX) in the presence of suitable noble metal catalyst:

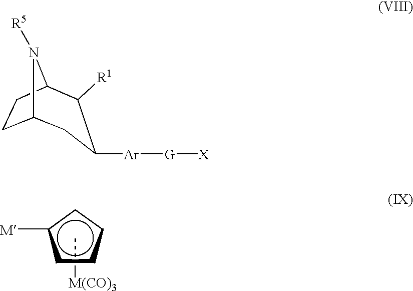

In formula (VIII), R⁵, R¹, Ar, and G are each as described above in formula (VII) and X is a halogen (e.g. fluorine, chlorine, bromine, iodine), preferably a chlorine or bromine. In formula (IX), M is as described above and M′ is an organometallic group. Examples of suitable organometallic group include, but are not limited to, those of the form trialkylstannyl or the like, preferably tributyl- or trimethylstannyl. According to the invention, a “suitable noble metal catalyst” includes, but is not limited to, zero-valent palladium complexes of the type tetrakis(triphenylphosphine)palladium (0) and the like. According to the invention, “under conditions sufficient” included any suitable nucleophilic addition reaction conditions or coupling reactions conditions such as, for example, Stille-type coupling.

As described above, the transition metal of a transition metal-cyclopentadienyl-tropane conjugate compound may be a radioisotope of the transition metal. Accordingly, the invention also provides radioisotopic transition metal-cyclopentadienyl-tropane conjugate compounds that may be used as a radiodiagnostic agent in various radiodiagnostic methods or radiotherapeutic methods. Such radioisotopic transition metal-cyclopentadienyl-tropane conjugate compounds may be prepared any means known in the art. See, for example, T. W. Spradau et al., Organometallics. 17: 2009-2017 (1998). According to the invention, a radiodiagnostic method administers to a mammal a pharmaceutically acceptable amount of at least one radioisotopic transition metal-cyclopentadienyl-tropane conjugate compound of the invention and then monitors uptake of the radioisotopic transition metal-cyclopentadienyl-tropane conjugate compound. Mixtures of radioisotopic transition metal-cyclopentadienyl-tropane conjugate compounds may be used. Uptake of the radioisotopic transition metal-cyclopentadienyl-tropane conjugate compound may be monitored by any means known in the art including nuclear medicine imaging technology such as, for example, SPECT imaging. A radioisotopic transition metal-cyclopentadienyl-tropane conjugate compound may be administered neat or in combination with a pharmaceutically acceptable carrier. As would be understood by one of skill in the art, a pharmaceutically acceptable amount will be determined on a case by case basis. Factors to be considered include, but are not limited to, the type of radioisotope, mode of administration (e.g. intravenous injection, oral administration, parenteral), physical characteristics of the one to which the radiodiagnostic is to be applied, and the like. According to the invention, the radiodiagnostic method may be used alone or in conjunction with other radiodiagnostic and/or therapeutic methods or treatments.

A transition metal-cyclopentadienyl-tropane conjugate compound of the invention may also be used in various pharmaceutical compositions. Such a pharmaceutical composition may be used in the treatment of disorders related to monoamine transporter activity including, but not limited to, Parkinson's disease and depression. According to the invention, such a pharmaceutical composition comprises a therapeutically effective amount of at least one transition metal-cyclopentadienyl-tropane conjugate compound of the invention, as described above, and a pharmaceutically acceptable carrier. According to the invention, mixtures of transition metal-cyclopentadienyl-tropane conjugate compounds may be used as well. A pharmaceutical composition of the invention may be, for example, a solid, liquid, suspension, or emulsion According to the invention, the pharmaceutical composition may be provided in sustained release or timed release formulations. A pharmaceutically acceptable carrier may be any such carrier, excipient, stabilizer, etc. known in the art as described, for example, in Remington's Pharmaceutical Sciences, Mack Publishing Co. (A. R. Gennaro edit. 1985). The choice of pharmaceutically acceptable carrier will vary, as recognized by one of skill in the art, depending upon, for example, the transition metal-cyclopentadienyl-tropane conjugate compound, physical characteristics of the one receiving the pharmaceutical composition, mode of administration (e.g. intravenous injection, oral administration, parenteral), and the like. A therapeutically effective amount, as recognized by one of skill in the art, will also be determined on a case by case basis. Factors to be considered include, but are not limited, to the disorder to be treated (e.g. Parkinson's disease, depression), the physical characteristics of the one suffering from the disorder, the transition metal-cyclopentadienyl-tropane conjugate compound, and the like. A pharmaceutical composition of the invention may be prepared by any means known in the art including, but not limited to, simply mixing a transition metal-cyclopentadienyl-tropane conjugate compound and a pharmaceutically acceptable carrier, each as described above.

The following examples are given to illustrate the invention. It should be understood, however, that the invention is not to be limited to the specific conditions or details described in these examples.

### EXAMPLES

### Example 1

Synthesis of N-(4-oxo-4-tricarbonylcyclopentadienylrhenio)-2β-hydroxymethyl-3β-(4-chlorophenyl)-nortropane (1a)

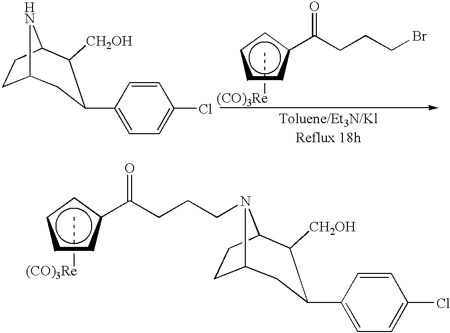

(4-Bromobutanoyl)cyclopentadienyltricarbonylrhenium (360 mg, 0.720 mmol) and potassium iodide (50 mg) were added successively to a solution of 2β-hydroxymethyl-3(-4-chlorophenyl)nortropane (100 mg, 0.36 mmol) and triethylamine (3 mL) in toluene (1.7 mL) in a 10 mL round bottom flask fitted with a reflux condenser. The mixture was refluxed under an argon atmosphere for 6 h. After cooling to room temperature, the solvent was removed on a rotary evaporator, and the residue was purified on a silica gel column (2% Et₃N/48%Et₂0/50% hexane), to yield the desired product as a brownish oil, 145 mg (58%). ¹H NMR (300 MHz, CD₃COCD₃) δ7.29 (m, 4H); 4.63 (m, 1H); 4.34 (m, 1H); 3.76 (1H, m); 3.37 (3H, s); 3.30 (1H, m); 3.10 (2H, m); 2.84 (3H, br); 2.68-2.40 (4H, m); 2.30 (1H, m); 2.10 (2H, m).

### Example 2

Synthesis of 2-Carbomethoxy-3-(tricarbonylcyclopentadienylrhenio)-trop-2-ene (1e)

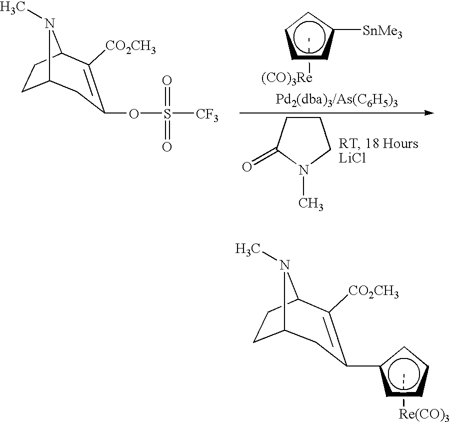

To a solution of Pd₂(dba)₃ (8 mg), As(C₆H₅)₃ (20 mg), LiCl (25 mg) and 8-methyl-3-trifluoromethanesulfonyloxy-8-aza-bicyclo[3.2.1]oct-2-ene-2-carboxylic acid methyl ester (165 mg, 0.5 mmol; Wust, et al., Deutsche Gesellschaftfur Nuclearmedizine. V. 36, Internationale Jahrestagung, Leipzig, Germany (1998)) in anhydrous degassed N-methylpyrrolidone (3 mL) was added trimethylstannyl-cyclopentadienyltricarbonylrhenium (320 mg, 0.6 mmol) in N-methylpyrrolidone (2 mL). The reaction was stirred overnight at room temperature, diluted with EtOAc, and filtered. The filtrate was washed with water, dried and concentrated. The resulting oil was purified through a silica gel column (hexane/ether/triethylamine, 70/30/5) to give 145 mg (55%) of the desired product as a brownish oil. ¹H NMR (300 MHz, CDCl₃) δ5.48 (m, 2H); 5.27 (m, 2H); 3.75 (s, 3H); 3.68 (d, 1H); 3.35 (m, 1H); 2.68 (m, 1H); 2.40 (s, 3H); 2.15 (m, 2H); 1.95 (m, 1H); 1.80 (d, 1H); 1.55 (m, 1H).

### Example 3

Synthesis of 3-(4-Chlorophenyl)-8-(3-tricarbonylrhenatocyclopentadienyloxy-carbonylpropyl)-8-aza-bicyclo[3.2.1 ]octane-2-carboxylic acid methyl ester (1b)

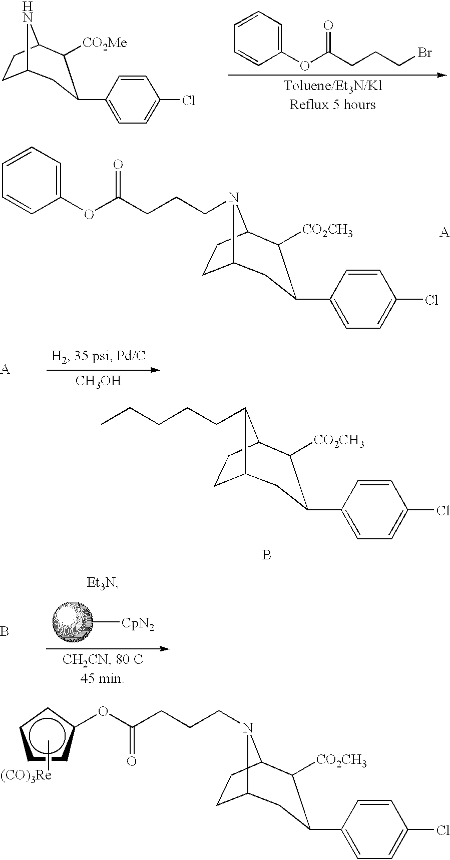

4-Bromobenzyl butyrate (1.3 g, 5 mmol) and potassium iodide (KI) (1 g) were added successively to a solution of 2β-carbomethoxy-3β-(4-chlorophenyl)nortropane (1.26 g, 4.5 mmol) and triethylamine (5 mL) in toluene (50 mL) in a round bottom flask fitted with a reflux condenser. The mixture was heated at reflux under an argon atmosphere overnight. After cooling to room temperature, the solvent was removed in vacuo and the residue was purified on a silica gel column (R_{f}=0.14, 2% Et₃N/18% Et₂O/80% hexane), to yield a colorless oil, 1.65 g (80%). 3-(4-Chlorophenyl)-8-(4-benzylbutyrate)-8-azabicyclo[3.2.1]octane-2-carboxylic acid methyl ester (460 mg, 1 mmol) was dissolved in MeOH (25 mL) and 25 mg Pd/C 3% was added. The reaction was shaken in H₂ atmosphere at 35 psi. After 24 h, the flask was purged, the catalyst was removed by filtration through Celite, and the solvent was removed in vacuo. The product (3.5 g, 95%) was used for the next step as such. [Et₂N₂][Br₃Re(CO)₃] (50.0 mg, 0.065 mmol) was dissolved in dry CH₃CN (2.0 mL) and treated with AgOTf (53.4 mg, 0.208 mmol) in one portion. The mixture was stirred for 5 min and the AgBr precipitate was removed by filtration, using a Pasteur pipette fitted with a cotton plug. The resulting colorless solution was added directly to a previously prepared solution containing the intermediate (40.4 mg, 0.110 mmol) and triethylamine (36.0 μL, 0.260 mmol) in dry CH₃CN (1 mL), leading to formation of a white precipitate. Polymer-supported diazocyclopentadiene (102.5 mg, 0.195 mmol, 1.90 mmol CpN₂/g polymer) was then added in one portion to the suspension. The flask was fitted with a condenser and the mixture was heated at 80° C. for 45 min under an argon atmosphere. After cooling to room temperature, the mixture was concentrated under a stream of nitrogen and purified on silica gel (2% Et₃N/13% EtOAc/80% hexane) to afford the desired product as a pale yellow oil, 38.1 mg (70%). ¹H NMR (300MHz, CDCl₃) δ7.36 (m, 5H); 7.21 (dd, 4H, J₁=8.1 Hz, J₂=8.7 Hz); 5.12 (s, 2H); 3.68 (m, 1H); 3.43 (3H, s); 3.37 (1H, m); 2.90 (2H, m); 2.50 (4H, m); 2.25 (2H, m); 2.00 (2H, m); 1.70 (4H, m).

### Example 4

Preparation of 3β-(4-Chlorophenyl)-8-(3-tricarbonyl-[^{99m}Tc] technetatocyclopentadienylcarbonylpropyl)-8-aza-bicyclo[3.2.1 ]octane-2β-carboxylic acid methyl ester.

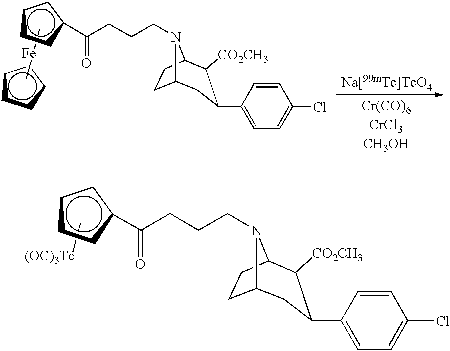

An aqueous solution of sodium [^{99m}Tc]pertechnetate obtained by elution of a ⁹⁹Mo/^{99m}Tc generator was evaporated to dryness under a stream of nitrogen gas while warming on a heating mantle. To the dry sodium ⁹⁹mTc (57.6 mCi) pertechnetate was added 500 μL methanol, 9.05 mg 3β-(4-Chlorophenyl)-8-(3-cyclopentadienylferratocyclopentadienylcarbonylpropyl)-8-aza-bicyclo[3.2.1 ]octane-2β-carboxylic acid methyl ester, 6.99 mg chromium hexacarbonyl, and 2.12 mg chromium trichloride. The vessel was sealed and heated from 85 to 154° C. in 35 min and held at 154-156° C. for 10 min. After cooling to room temperature, the contents were transferred to another glass vessel and the methanol was removed by evaporation with nitrogen gas. The contents were transferred to a silica solid phase extraction cartridge with dichloromethane and eluted with hexane/triethylamine (95/5). The solvent was evaporated and the residue was purified by gravity column chromatography on silica gel 60 (15 g), eluting with a gradient from hexane/triethylamine (95/5) to hexane/ethyl acetate/triethylamine (90/5/5). The radioactive fractions containing product were pooled and the solvent was evaporated. The residue was reconstituted with 0.4 mL ethanol and 8 mL 0.9% sodium chloride solution containing 0.1 mg/mL L-ascorbic acid. Final product was 7.45 mCi (14.4 % yield, decay-corrected), with radiochemical purity >99.9%, determined by reverse phase high pressure liquid chromatography on a C₁₈ column (4.6×250 mm) with methanol/water/triethylamine (80/20/0.2), 1.0 mL/min.

### Example 5

Preparation of 3β-(4-Chlorophenyl)-8-(4-cyclopentadienyltricarbonyl rhenium-butyl)-8-azabicyclo[3.2.1 ]octane-2β-carboxylic acid methyl ester (1d)

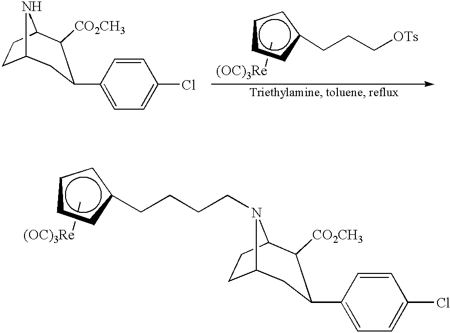

To a solution of 2β-carbomethoxy-3β-(4-chlorophenyl)nortropane (49.8 mg, 0.178 mmol) and 4-p-Toluenesulfonyloxy-1-(cyclopentadienyltricarbonyl rhenium)-butane (100 mg, 0.178 mmol) in toluene (10 mL) was added triethylamine (250 μL, 1.79 mmol) and KI (5.6 mg, 0.045 mmol) successively. The mixture was then heated to reflux and stirred overnight. After the solution had cooled to RT, all volatile material was removed in vacuo. Purification (R_{f}0.24 in 2% Et₃N/28% Et₂O/70% Hexanes) afforded the desired product as a yellow oil (61 mg, 51%). ¹H NMR (CDCl₃, 500 MHz): δ7.23 (AA′ of AA′XX′, 2H, J_{AX}=8.59 Hz, J_{AA}=2.29 Hz), 7.18 (XX′ of AA′XX′, 2H, J_{AX}=8.54 Hz, J_{XX}=2.59 Hz), 5.24 (m, 4H), 3.66 (dd, 1H, J=7.12, 3.29 Hz), 3.48 (s, 3H), 3.38 (dt, 1H, J=6.63, 3.32 Hz), 2.97 (dt, 1H, J=12.80, 5.06 Hz), 2.89 (m, 1H), 2.54 (td, 1H, J=12.37, 2.99 Hz), 2.39 (m, 2H), 2.25 (ABt, 2H, J_{AB}=12.19 Hz, Jₜ=6.68 Hz), 2.09 (tdd, 1H, J=12.70, 7.10, 4.09 Hz), 1.99 (tdd, 1H, J=12.76, 6.57, 4.66 Hz), 1.71 (ddd, 1H, J=13.35, 9.45, 4.28 Hz), 1.65 (dddd, 1H, J=12.45, 4.74, 3.40, 1.18 Hz), 1.61 (ddd, 1H, J=13.39, 9.43, 4.28 Hz), 1.52 (m, 2H), 1.43 (m, 2H). ¹³C NMR (CDCl₃, 125 MHz): δ194.6, 171.9, 141.8, 131.4, 128.7, 128.0, 111.8, 83.6, 82.9, 82.8, 62.9, 61.3, 52.9, 52.8, 51.0, 34.0, 33.8, 29.2, 28.5, 27.9, 26.0. MS (EI, 70 eV): m/z (relative intensity) 669(M+, 62), 638(9), 610(14), 458(51), 429(38), 292(100), 97(56). HRMS Calcd for C₂₇H₂₉ClNO₅ ¹⁸⁷Re: 669.1292. Found: 669.1297.

### Example 6

Synthesis of 8-Methyl-3β-[4 carbonyl -(cyclopentadienyltricarbonyl rhenium)-phenyl]-8-azabicyclo[3.2.1 ]octane-2β-carboxylic acid methyl ester (1c)

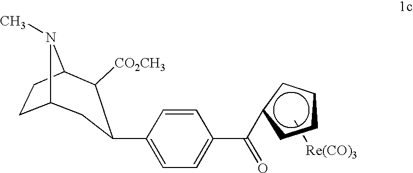

To a solution of cyclopentadienyltricarbonyl rhenium carbonyl chloride (38.5 mg, 96.8 μmol) and benzyl chloro-bis-(triphenylphosphino) palladium (0.37 mg, 0.48 μmol) in chloroform (1 mL) was added 8-methyl-3β-[4-(trimethyl-stannanyl)-phenyl]-8-azabicyclo[3.2.1]octane-2-carboxylic acid methyl ester (42.9 mg, 0.102 mmol) as a solution in chloroform (1 mL). The flask was fitted with a reflux condenser, and the solution was heated to reflux for 1 h or until palladium black precipitated from the solution. After being cooled to RT, the yellow solution was placed directly on a silica column. Purification (R_{f}0.24 in 2% Et₃N/68% Et₂O/30% Hexanes) afforded the desired product as a white solid (55 mg, 92%). ¹H NMR (CDCl₃, 500 MHz): δ7.72 (AA′ of AA′XX′, 2H, J_{AX}=8.32 Hz, J_{AA}=1.95 Hz), 7.35 (XX′ of AA′XX′, 2H, J_{AX}=8.35 Hz, J_{XX}=2.15 Hz), 6.06 (t, 2H, J=2.26 Hz), 5.44 (t, 2H, J=2.30 Hz), 3.60 (dd, 1H, J=6.56, 2.92 Hz), 3.51 (s, 3H), 3.39 (m, 2H), 3.04 (dt, 1H, J=12.69, 5.20 Hz), 2.96 (m, 1H), 2.61 (td, 1H, J=12.52, 2.78 Hz), 2.24 (m, 1H), 2.24 (s, 3H), 2.13 (m, 1H), 1.73 (m, 2H), 1.62 (ddd, 1H, J=13.29, 9.51, 4.14 Hz). ¹³C NMR (CDCl₃, 125 MHz): δ192.0, 189.3, 171.9, 148.9, 134.8, 128.3, 127.6, 96.1, 89.7, 89.6, 85.2, 65.2, 62.1, 52.5, 51.2, 41.9, 33.9, 33.7, 25.8, 25.1. MS (EI, 70 eV): m/z (relative intensity) 621 (M⁺, 24), 97(53), 83(100). HRMS Calcd for C₂₅H₂₄NO₆ ¹⁸⁷Re: 621.1161. Found: 621.1155

### Example 7

Dopamine Transporter Binding Studies for Transition Metal-Cyclopentadienyl-Tropane Conjugate Compounds 1a, 1b, 1c, 1d and 1e.

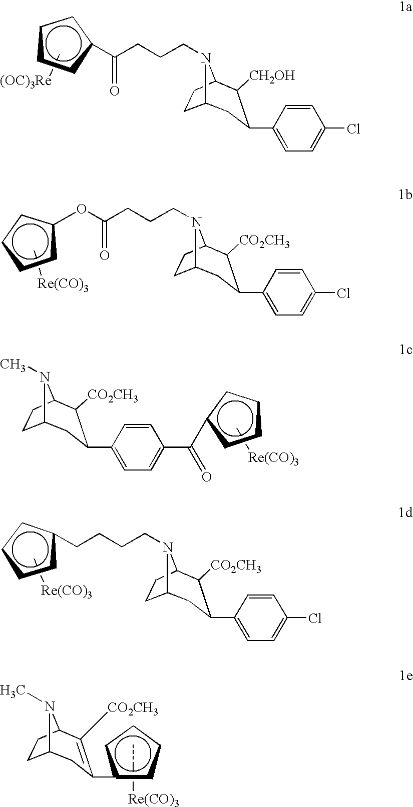

The binding affinities (mean±SEM) of compounds 1a, 1b, 1c, 1d, and 1e for the dopamine transporter (DAT), the serotonin transporter (5-HTT), and norepinephrine (NET) were evaluated in, respectively, rat striatal and cortical tissues according to methods described in Tamagnan et al., Advances in Neurology, Parkinson's Disease. 80: 91-103 (1999). The results are summarized in Table 1 below. β-CIT was run concurrently as a control.

TABLE 1

| | | Cp Linkage | | DAT | 5-HTT | NET |
|---|---|---|---|---|---|---|
| Compound | Position | (Pendant) | 2β- | Kᵢ (nM) | Kᵢ (nM) | Kᵢ (nM) |
| 1a | N- | Ketone | Alcohol | 13.0 ± 1.8 | 13.3 ± 1.0 | 74.0 ± 8.2 |
| 1b | N- | Carboxylate | Ester | 4.18 ± 0.33 | 5.28 ± 0.21 | 74.0 ± 8.2 |
| 1c | 3β-4′- | Ketone | Ester | >10,000 | >10,000 | >30,000 |
| 1d | N- | Alkyl | Ester | 5.45 ± 0.64 | 1.14 ± 0.16 | 199 ± 30 |
| 1e | 3β- | — | Ester | ˜10,000 | >30,000 | >10,000 |
| β-CIT | — | — | Ester | 0.96 ± 0.15 | 0.46 ± 0.06 | 2.8 ± 0.4 |

It should be understood that the foregoing discussion and examples merely present a detailed description of certain preferred embodiments. It will be apparent to those of ordinary skill in the art that various modifications and equivalents can be made without departing from the spirit and scope of the invention. All the patents, journal articles and other documents discussed or cited above are herein incorporated in their entirety by reference.

The claimed invention is:

1. A transition metal-cyclopentadienyl-tropane conjugate compound comprising a transition metal, a cyclopentadienyl group, and a tropane moiety.

2. A transition metal-cyclopentadienyl-tropane conjugate compound of formula (I): 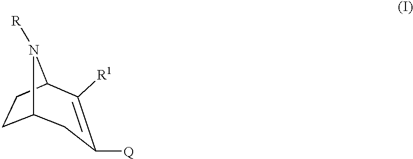
wherein:
R¹ is CO₂R² or CH₂ OR²;
R and R² are, independently, H, linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
Q is substituted or unsubstituted CpM(CO)₃;
M is Re, Tc, Mn or a radioisotope thereof; and
Cp is a cyclopentadienyl group.

3. The transition metal-cyclopentadienyl-tropane conjugate compound of claim 2, wherein R¹ is CO₂ R².

4. The transition metal-cyclopentadienyl-tropane conjugate compound of claim 3, wherein R² is a methyl group.

5. The transition metal-cyclopentadienyl-tropane conjugate compound of claim 4, wherein R is a methyl group and Q is CpRe(CO)₃.

6. The transition metal-cyclopentadienyl-tropane conjugate compound of claim 2, wherein M is a radioisotope of Re, Tc, or Mn.

7. The transition metal-cyclopentadienyl-tropane conjugate compound of claim 2, wherein R¹ is CH₂OR².

8. A method of preparing a transition metal-cyclopentadienyl-tropane conjugate compound comprising the step of reacting a transition metal-cyclopentadienyl compound and a tropane moiety under conditions sufficient to form the transition metal-cyclopentadienyl-tropane conjugate.

9. A method of preparing a transition metal-cyclopentadienyl-tropane conjugate compound comprising the steps of:
reacting a tropane derivative compound of formula (II): 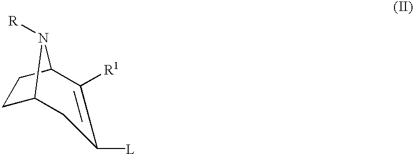
wherein:
R¹ is CO₂R² or CH₂ OR²;
R and R² are independently H, linear or branched C₁-C₁₂ alkyl C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S; and
L is B(OH)₂,
with a transition metal-cyclopentadienyl compound under conditions sufficient to form the transition metal-cyclopentadienyl-tropane conjugate compound of formula (I): 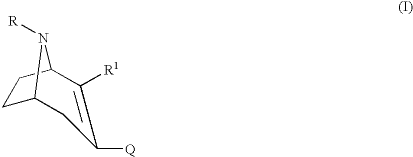
wherein:
R¹ is CO₂R² or CH₂ OR²;
R and R² are, independently, H, linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
Q is substituted or unsubstituted CpM(CO)₃;
M is Re, Tc, Mn or a radioisotope thereof, and
Cp is a cyclopentadienyl group.

10. A radiodiagnostic method comprising the steps of:
administering to a mammal a pharmaceutically acceptable amount of a compound of claim 6; and
monitoring uptake of said compound.

11. A pharmaceutical composition for the treatment of disorders related to monoamine transporter activity comprising a therapeutically effective amount of a compound of claim 1 and a pharmaceutically acceptable carrier.

12. A transition metal-cyclopentadienyl-tropane conjugate compound of formula (III): 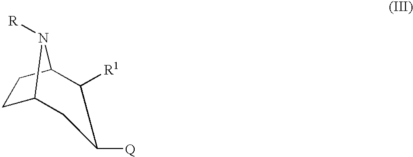
wherein:
R¹ is CO₂R² or CH₂ OR²;
R and R² are independently H, linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
Q is substituted or unsubstituted CpM(CO)₃;
M is Re, Tc, Mn or a radioisotope thereof; and
Cp is a cyclopentadienyl group.

13. The transition metal-cyclopentadienyl-tropane conjugate compound of claim 12, wherein R¹ is CO₂ R².

14. The transition metal-cyclopentadienyl-tropane conjugate compound of claim 13, wherein R² is a methyl group.

15. The transition metal-cyclopentadienyl-tropane conjugate compound of claim 14, wherein R is a methyl group and Q is CpRe(CO)₃.

16. The transition metal-cyclopentadienyl-tropane conjugate compound of claim 12, wherein M is a radioisotope of Re, Tc, or Mn.

17. The transition metal-cyclopentadienyl-tropane conjugate compound of claim 12, wherein R¹ is CH₂OR².

18. A method of preparing a transition metal-cyclopentadienyl-tropane conjugate compound comprising the steps of:
reducing a transition metal-cyclopentadienyl-tropane conjugate compound of formula (I): 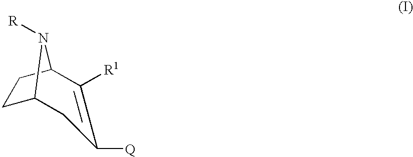
wherein:
R¹ s CO₂R² or CH₂OR²;
R and R² are, independently, H, linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
Q is substituted or unsubstituted CPM(CO)₃;
M is Re, Tc, Mn or a radioisotope thereof; and
Cp is a cyclopentadienyl group;
under conditions sufficient to form the transition metal-cyclopentadienyl-tropane conjugate compound of formula (III): 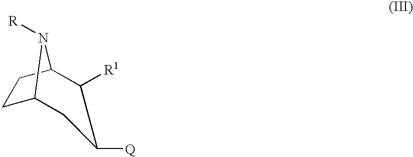
wherein:
R¹ is CO₂R² or CH₂ OR²;
R and R² are independently H, linear or branched C₁-C₁₂ alkyl C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂heteroaromatic group wherein the heteroatom is at least one of N, O, and S;
Q is substituted or unsubstituted CpM(CO)₃;
M is Re, Tc, Mn or a radioisotope thereof; and
Cp is a cyclopentadienyl group.

19. A radiodiagnostic method comprising the steps of:
administering to a mammal a pharmaceutically acceptable amount of a compound of claim 16; and
monitoring uptake of said compound.

20. A pharmaceutical composition for the treatment of disorders related to monoamine transporter activity comprising a therapeutically effective amount of a compound of claim 12 and a pharmaceutically acceptable carrier.

21. A transition metal-cyclopentadienyl-tropane conjugate compound of formula (IV): 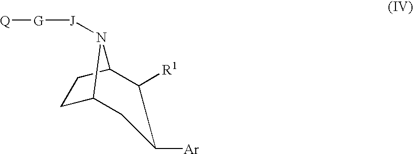
wherein:
Q is substituted or unsubstituted CpM(CO)₃;
M is Re, Tc, Mn or a radioisotope thereof;
Cp is a cyclopentadienyl group;
G is a direct link, —C(O)—, —R²NC(O)—, —CH═CH—, —S(O)—, —SO₂—, —OC(O)—, or —CH₂—O—(CH₂)ᵣ—O—(CH₂)ₛ—;
r is an integer from 1-4;
s is an integer from 0-4, where r+s<8;
J is —(CH₂)ₙ—;
n is an integer from 1-8;
R¹ is CO₂R² or CH₂OR³;
R² and R⁴ are, independently, H, a linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
R³ is H, —CH₂—O—(CH₂)ₜ—O—(CH₂)ᵥ—, a linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
t is an integer from 1-4;
v is an integer from 0-4, where t+v<8;
Ar is a substituted or unsubstituted phenyl group; with the proviso that when R¹ is CO₂CH₃ or CH₂OH, G is not C(O).

22. The transition metal-cyclopentadienyl-tropane conjugate compound of claim 21, wherein Q is CpRe(CO)₃, n is 3, R¹ is CH₂OH, and Ar is p-chlorophenyl.

23. The transition metal-cyclopentadienyl-tropane conjugate compound of claim 21, wherein G is a —OC(O)— group.

24. The transition metal-cyclopentadienyl-tropane conjugate compound of claim 21, wherein M is a radioisotope of Re, Tc, or Mn.

25. A method of preparing a transition metal-cyclopentadienyl-tropane conjugate compound comprising the steps of:
reacting a tropane moiety of formula (V): 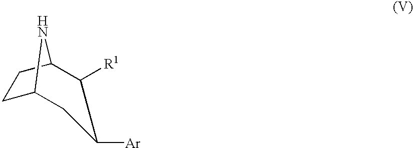
wherein:
R¹ is CO₂R² or CH₂OR³;
R² is H, linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
R³ is H, —CH₂—O—(CH₂)ₜ—O—(CH₂)ᵥ—, a linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
t is an integer from 1-4;
v is an integer from 0-4, where t+v<8; and
Ar is a substituted or unsubstituted phenyl group with a transition metal-cyclopentadienyl compound under conditions sufficient to form the transition metal-cyclopentadienyl-tropane conjugate compound of formula (IV): 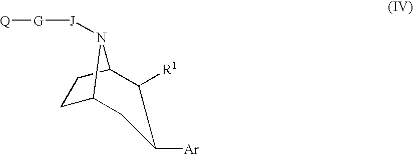
wherein:
Q is substituted or unsubstituted CpM(CO)₃;
M is Re, Tc, Mn or a radioisotope thereof;
Cp is a cyclopentadienyl group;
G is a direct link, —C(O)—, —R²NC(O)—, —CH═CH—, —S(O)—, —SO₂—, —OC(O)—, or —CH₂—O—(CH₂)ᵣ—O—(CH₂)ₛ—;
r is an integer from 1-4;
s is an integer from 0-4, where r+s<8;
J is —(CH₂)ₙ—;
n is an integer from 1-8;
R¹ is CO₂R² or CH₂OR³;
R² and R⁴ are, independently, H, a linear or branched C₁-C₁₂ alkyl, C₂-C₁₂ alkenyl, C₂-C₁₂ alkynyl, C₆-C₁₂ aryl, C₃-C₁₂cycloalkyl, C₃-C₁₂heterocycloalkyl, or C₁-C₁₂ heteroaromatic group wherein the heteroatom is at least one of N, O, and S;
R³ is H, —CH₂—O—(CH₂)ₜ—O—(CH₂)ᵥ—, a linear or branched Cl-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
t is an integer from 1-4;
v is an integer from 0-4, where t+v<8;
Ar is a substituted or unsubstituted phenyl group; with the proviso that when R¹ is CO₂CH₃ or CH₂OH, G is not C(O).

26. A radiodiagnostic method comprising the steps of:
administering to a mammal a pharmaceutically acceptable amount of a compound of claim 24; and
monitoring uptake of said compound.

27. A pharmaceutical composition for the treatment of disorders related to monoamine transporter activity comprising a therapeutically effective amount of a compound of claim 21 and a pharmaceutically acceptable carrier.

28. A transition metal-cyclopentadienyl-tropane conjugate compound of formula (VI): 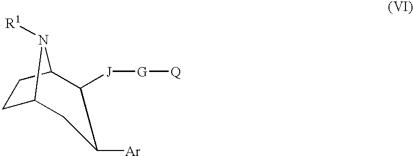
wherein:
Q is substituted or unsubstituted CpM(CO)₃;
M is Re, Tc, Mn or a radioisotope thereof;
Cp is a cyclopentadienyl group;
G is a direct link, —C(O)—, —R²NC(O)—, —CH═CH—, —S(O)—, —SO₂—, —OC(O)—, or —CH₂—O—(CH₂)ᵣ—O—(CH₂)ₛ—;
r is an integer from 1-4;
s is an integer from 0-4, where r+s<8;
J is —(CH₂)ₙ—;
n is an integer from 1-8;
R¹ is CO₂R² or CH₂OR³;
R² and R⁴ are, independently, H, a linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
R³ is H, —CH₂—O—(CH₂)ₜ—O—(CH₂)ᵥ—, a linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
t is an integer from 1-4;
v is an integer from 0-4, where t+v<8;
Ar is a substituted or unsubstituted phenyl group;
with the proviso that when R¹ is CO₂CH₃ or CH₂OH, G is not C(O).

29. The transition metal-cyclopentadienyl-tropane conjugate compound of claim 28, wherein Q is CpRe(CO)₃, n is 3, R¹ is CH₂OH, and Ar is p-chlorophenyl.

30. The transition metal-cyclopentadienyl-tropane conjugate compound of claim 28, wherein G is a —OC(O)— group.

31. The transition metal-cyclopentadienyl-tropane conjugate compound of claim 28, wherein M is a radioisotope of Re, Tc, or Mn.

32. A method of preparing a transition metal-cyclopentadienyl-tropane conjugate compound comprising the steps of:
reacting a tropane moiety of formula (X): 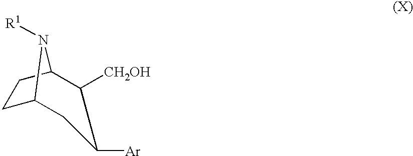
wherein:
R¹ is CO₂R² or CH₂OR³;
R² is H, linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
R³ is H, —CH₂—O—(CH₂)ₜ—O—(CH₂)ᵥ—, a linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
t is an integer from 1-4;
v is an integer from 0-4, where t+v<8; and
Ar is a substituted or unsubstituted phenyl group with a transition metal-cyclopentadienyl compound under conditions sufficient to form the transition metal-cyclopentadienyl-tropane conjugate compound of formula (VI): 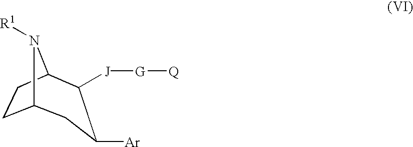
wherein:
Q is substituted or unsubstituted CpM(CO)₃;
M is Re, Tc, Mn or a radioisotope thereof;
Cp is a cyclopentadienyl group;
G is a direct link, —C(O)—, —R²NC(O)—, —CH═CH—, —S(O)—, —SO₂—, —OC(O)—, or —CH₂—O—(CH₂)ᵣ—O—(CH₂)ₛ—;
r is an integer from 1-4;
s is an integer from 0-4, where r+s<8;
J is —(CH₂)ₙ—;
n is an integer from 1-8;
R¹ is CO₂R² or CH₂OR³;
R² and R⁴ are, independently, H, a linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
R³ is H, —CH₂—O—(CH₂)ₜ—O—(CH₂)ₛ—, a linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S;
t is an integer from 1-4;
v is an integer from 0-4, where t+v<8;
Ar is a substituted or unsubstituted phenyl group.

33. A radiodiagnostic method comprising the steps of:
administering to a mammal a pharmaceutically acceptable amount of a compound of claim 31; and
monitoring uptake of said compound.

34. A pharmaceutical composition for the treatment of disorders related to monoamine transporter activity comprising a therapeutically effective amount of a compound of claim 28 and a pharmaceutically acceptable carrier.

35. A transition metal-cyclopentadienyl-tropane conjugate compound of formula (VII): 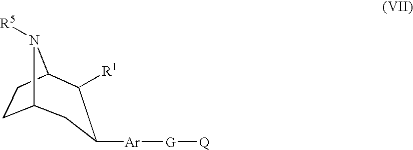
wherein:
Q is substituted or unsubstituted CpM(CO)₃;
M is Re, Tc, Mn or a radioisotope thereof,
Cp is a cyclopentadienyl group;
G is —C(O)—, —R²NC(O)—, —CH═CH—, —S(O)—, —SO₂—, —OC(O)—, or —Ph—C(O)—;
R¹ is CO₂R² or CH₂OR³; R², R³, R⁴, and R⁵ are, independently, H, linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S; and
Ar is a substituted or unsubstituted phenyl group.

36. A method of making a transition metal-cyclopentadienyl-tropane conjugate compound comprising the step of:
reacting a nucleophilic substituted tropane moiety of formula (VIII): 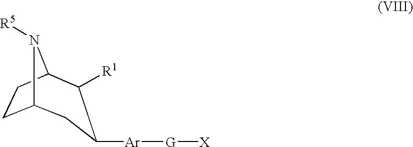
wherein R⁵, R¹, Ar, and G
G is —C(O)—, —R²NC(O)—, —CH═CH—, —S(O)—, —SO₂—, —OC(O)—, or —Ph—C(O)—;
R¹ is CO₂R or CH₂OR³;
R² and R³ are, independently, H, linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S; and X is a halogen;
with a metal-cyclopentadienyl compound of formula (IX): 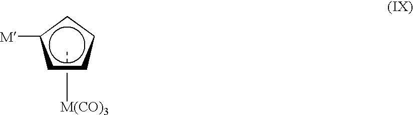
wherein M is Re, Tc, Mn or a radioisotope thereof; and
M′ is an organometallic group
in the presence of suitable noble metal catalyst to form a transition metal-cyclopentadienyl-tropane conjugate compound of formula (VII): 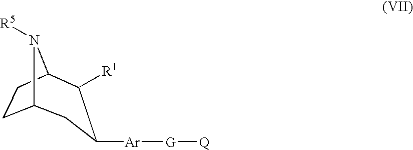
wherein:
Q is substituted or unsubstituted CpM(CO)₃;
M is Re, Tc, Mn or a radioisotope thereof; Cp is a cyclopentadienyl group;
G is —C(O)—, —R²NC(O)—, —CH═CH—, —S(O)—, —SO₂—, —OC(O)—, or —Ph—C(O)—;
R¹ is CO₂R² or CH₂OR³;
R², R³, R⁴, and R⁵ are, independently, H, linear or branched C₁-C₁₂ alkyl, C₂-C₁₂ alkenyl, C₂-C₁₂ alkynyl, C₆-C₁₂ aryl, C₃-C₁₂ cycloalkyl, C₃-C₁₂ heterocycloalkyl, or C₁-C₁₂ heteroaromatic group wherein the heteroatom is at least one of N, O, and S; and
Ar is a substituted or unsubstituted phenyl group.
